(19) United States
(12) Patent Application Publication
(10) Pub. No.: US 2014/0278796 A1
(43) Pub. Date: Sep. 18, 2014

(54) Identifying Target Audience for a Product or Service

(71) Applicants: Nick Salvatore Arini, Botley (GB); Simon Michael Rowe, Finchampstead (GB); Roman Kirillov, London (GB)

(72) Inventors: Nick Salvatore Arini, Botley (GB); Simon Michael Rowe, Finchampstead (GB); Roman Kirillov, London (GB)

(21) Appl. No.: 13/830,726

(22) Filed: Mar. 14, 2013

(51) Int. Cl. G06Q 30/02

(52) U.S. Cl. CPC G06Q 30/0204
USPC 705/7.33

(57) ABSTRACT

A method for selecting potential customers for a product/service using a computer server is provided. The computer server collects information consumption activity data, conversion data, and demographic data from panelists that have agreed to share their data with the computer server. For each panelist, the computer server identifies a set of product/service keywords from the information consumption activity data associated with the panelist. For each keyword, the computer server aggregates the demographic data of the panelists associated with the keyword using their conversion data and generates a set of demographic attributes in order to characterize potential customers of the product/service. Subsequently, in response to a request from a client device for characterizing potential customers of a product/service, the computer server identifies product/service keywords and then generates a demographic characterization for the product/service by aggregating the demographic attributes associated with the keywords.

### TECHNICAL FIELD

The disclosed implementations relate generally to identifying target audience for a product or service marketed on the Internet and/or TV channels, and in particular, to systems and methods for identifying potential customers for a product/service from analyzing data relating to information consumption activities by a group of panelists.

### BACKGROUND

People are spending more and more time on the Internet, e.g., browsing news, entertainment and social media web sites; conducting business transactions; and purchasing or selling products/services. As a result, companies are increasing their efforts to reach potential customers through on-line advertising. However, due to different demographic sectors of the public having unique preferences regarding where to spend their time and money on the Internet, it is a challenge for advertisers to know where to focus their online advertising dollars. For example, college students may be more interested in visiting a sports related website like www.ncaa.org, but young mothers would probably like to spend more time on websites that provide infant related information. Therefore, it is not the most efficient way for a company to promote its products or services by merely placing its advertisements on a website based on its popularity without considering the demographic nature of the visitors of the website.

### SUMMARY

In accordance with some implementations described below, a method for selecting potential customers for a product/service is performed at a computer server having memory and one or more processors. The computer server collects information consumption activity data, conversion data, and demographic data from a plurality of panelists and identifies a set of product/service keywords for each panelist from the information consumption activity data associated with the panelist. For each product/service keyword, the computer server then aggregates the demographic data of those panelists associated with the product/service keyword using the conversion data and generates a set of demographic attributes from the aggregated demographic data in order to characterize potential customers of the product/service.

In accordance with some implementations described below, a method for generating a demographic characterization for a product/service is performed at a computer server having memory and one or more processors. In response to receiving from a client device a request to identify potential customers of a product/service, the computer server determines one or more categories for the product/service. For each category, the computer server identifies a set of product/service keywords, each product/service keyword having an associated set of demographic attributes characterizing potential customers of the product/service. The computer server then generates a demographic characterization for the product/service by aggregating the sets of demographic attributes associated with the respective sets of product/service keywords and returns information about the demographic characterization for the product/service for display at the client device.

In accordance with some implementations described below, a computer system for generating a demographic characterization for a product/service is provided. The computer system includes one or more processors and memory for storing one or more programs. The programs, when executed by the one or more processors, cause the computer system to perform the following instructions: receiving from a client device a request for identify potential customers of a product/service; determining one or more categories for the product/service; identifying a set of product/service keywords for each category, each product/service keyword having an associated set of demographic attributes characterizing potential customers of the product/service; generating a demographic characterization for the product/service by aggregating the sets of demographic attributes associated with the respective sets of product/service keywords; and returning information about the demographic characterization for the product/service for display at the client device.

In accordance with some implementations described below, a computer system for selecting potential customers for a product/service is provided. The computer system includes one or more processors and memory for storing one or more programs. The programs, when executed by the one or more processors, cause the computer system to perform the following instructions: collecting one or more of information consumption activity data, conversion data, and demographic data from a plurality of panelists; identifying a set of product/service keywords for each panelist from the information consumption activity data associated with the panelist; for each of the set of product/service keywords: aggregating the demographic data of the plurality of panelists who are associated with the product/service keyword using the conversion data; and generating a set of demographic attributes from the aggregated demographic data in order to characterize potential customers of the product/service.

### BRIEF DESCRIPTION OF DRAWINGS

The aforementioned implementation of the invention as well as additional implementations will be more clearly understood as a result of the following detailed description of the various aspects of the invention when taken in conjunction with the drawings. Like reference numerals refer to corresponding parts throughout the several views of the drawings.

FIG. 1 is a block diagram illustrating a distributed network environment including clients (some of which being identified as panelists), Internet, and a survey system for analyzing the information consumption activities by the panelists and providing a demographic characterization of a product/service in response to a client request in accordance with some implementations.

FIG. 2 is a block diagram illustrating different components of the survey system that are configured for analyzing the information consumption activities by the panelists and providing a demographic characterization of a product/service in response to a client request in accordance with some implementations.

FIGS. 3A and 3B are flow charts illustrating how the survey system analyzes the information consumption activities and other data associated with the panelists in order to characterize potential customers of the product/service in accordance with some implementations.

FIGS. 4A and 4B are flow charts illustrating how the survey system generates a demographic characterization for a product/service in response to a request for identifying potential customers of the product/service in accordance with some implementations.

FIG. 5 is an exemplary screenshot of a demographic characterization of a product/service displayed on a client device in accordance with some implementations.

### DETAILED DESCRIPTION

FIG. 1 is a block diagram illustrating a distributed network environment including clients 20 (some of which being identified as panelists 10-1 and 10-2), the Internet 30, and a survey system 40 for analyzing the information consumption activities of the panelists and providing a demographic characterization of a product/service in response to a client request in accordance with some implementations. Depending on the context, a client in the present application may refer to an electronic device, e.g., a desktop, laptop, tablet, or smartphone, etc., through which an individual can access the Internet. For example, when a marketing staff member from a company plans to issue a query asking the survey system 40 or identify potential customers for one of the company's products/services, the marketing staff member may use a client 20 to send such request and view a response to the request.

In some cases, a panelist refers to an individual and associated terminal devices used by the individual for accessing the Internet. For example, a data collection agency may invite a group of individuals to participate in a program wherein the individuals (or “panelists”) voluntarily agree to allow the agency to collect information relating to their web browsing and TV viewing activities, e.g., at home with/without compensation. In addition, the panelists also agree to provide their demographic information to the data collection agency so that it is possible to associate their respective web browsing and TV viewing activities with different demographic sectors. This allows the agencies to derive information useful for associating a product/service with a set of demographic attributes.

As shown in FIG. 1, a panelist 10-1 typically provides four different types of data to the survey system 40, i.e., web search history 11, web browsing data 13, TV viewing data 14, and conversion data 12. The web search history 11 identifies one or more search queries submitted by the panelist 10-1 and associated search results. In some implementations, the web search history 11 identifies hyperlinks clicked by the panelist in the search results and the amount of time the panelist spends on the search results. The web browsing data 13 identifies websites (including web pages) visited by a panelist during a predefined time period. In some implementations, the web browsing data 13 also indicates how long the panelist spends on an individual website or web page. In some implementations, a set-top box (or a modem) is installed at a panelist's house. The set-top box not only keeps track of the panelist's data traffic to/from the Internet but also records information about TV programs watched by the panelist, i.e., the TV viewing data 14 that may include the channel watched by the panelist, the title of a program played on the channel, and the length of time that the panel spends watching the TV program. The web search history 11, the web browsing data 13, and the TV viewing data 14 are, collectively, referred to as “information consumption activity data” in the present application. But one skilled in the art would understand that the information consumption activity data generated by a panelist is not limited to these three types. Note that whatever information is being collected from a panelist is subject to the panelist's explicit agreement, entered into upon becoming a panelist.

The conversion data 12 indicates the success of a marketing campaign. For example, the click-through rate for a particular advertisement is one type of conversion data 12 that measures the likelihood of a panelist clicking on a product/service promotion message on a web page (e.g., in some implementations, the click-through rate is the ratio of clicks to presentations for a particular advertisement). The conversion data 12 may also include information indicating whether a panelist has purchased a product/service after viewing the product/service's promotion message on the Internet or on TV. As described below, the conversion data 12 is useful when the survey system 40 determines a set of demographic attributes associated with preferred customers for a product/service. For example, if there is a high conversion rate (whether it is measured by the click-through rate or the number of actual commercial transactions) for a product/service among a particular demographic sector of the public, the demographic attributes unique to this sector can be given more weight as well when it comes to online advertising. Accordingly, when a company tries to promote a product/service of similar nature, the company can also target the demographic sector as the main source of potential customers and launch campaigns at venues (e.g., websites or TV channels/programs) popular among visitors/viewers from the same demographic sector.

In sum, the survey system 40 collects information consumption activity data and conversion data from panelists 10-1, 10-2 and stores that data in the panelist information consumption activity database 107. The data in the panelist information consumption activity database 107 serves as raw data to be processed by the survey system 40 (more specifically, the analytics module 110). From such data, the analytics module 110 derives a set of product/service keywords for each panelist. The set of product/service keywords indicates what type of products or services in which the panelist might be interested. Typically, a product/service can be characterized using one or multiple (e.g., 5) keywords and similar products/services may share some keywords in common. For example, if the information consumption activity data includes many occurrences of the website www.nba.com, then the analytics module 110 may associate the panelist with the keyword “basketball.” If the information consumption activity data includes many occurrences of the website www.cnbc.com, the analytics module 110 may associate the panelist with keywords like “stock” and “investment.”

In some implementations, the survey system 40 includes a website-keyword model 101, a web search-keyword model 103, and a TV program-keyword model 105 for associating a panelist with an appropriate set of product/service keywords based on the panelist's information consumption activity data. The three models may be generated by conducting a market survey among a group of users/viewers, e.g., by providing a list of candidate keywords and letting the users/viewers pick those that most accurately characterize a website or a TV program based on their opinions. Alternatively, some models may be generated and provided to the survey system 40 by a third-party entity by aggregating a sufficient number of data samples from a group of users/viewers. For example, it is possible to associate a web search query with a set of keywords based on their occurrence frequencies in the search results corresponding to the search query.

Based on one or more of these models, the analytics module 110 analyzes the information consumption activity data associated with each individual panelist such as websites visited by the panelist, web searches submitted by the panelist, and TV programs watched by the panelist, and derives a set of keywords for characterizing products and/or services that the panelist may be interested in purchasing. For example, for a website (including a web page), the analytics module 110 identifies one or more keywords associated with the website in the website-keyword model. It is possible that a panelist may visit many similar websites that share some keywords in common. In some implementations, the analytics module 110 assigns a weight to a keyword. In some implementations, the weight may be dependent upon the popularity of the website on the Internet, the amount of time that the panelist spends on the website, how well the keyword weight characterizes the website, etc. Therefore, if a particular keyword is associated with multiple websites visited by the panelist, the analytics module 110 aggregates their weights together to indicate the relevance between the panelist and this particular keyword. Similar approaches can be applied to the web search history and the TV viewing data. In some implementations, the analytics module 110 only identifies a predefined number of keywords for a panelist and stores this relationship in the panelist-keyword database 109. For example, the analytics module 110 may choose a keyword for a panelist only if the weight associated with the keyword is higher than a certain level. Alternatively, the analytics module 110 may choose the top-N (e.g., 5) keywords ranked by their weights for each panelist and stores them in the panelist-keyword database 109. In other words, the analytics module 110 converts the information consumption activity data that represents the specific events associated with a panelist into a more abstractive representation in the form of a set of keywords. As will be described below, a keyword may be associated with a particular type of product/service. It is possible to define a relationship between a panelist and a product/service that the panelist may be interested in using the keywords.

Multiple issues have to be resolved before the information in the panelist-keyword database 109 can be used for predicting or identifying potential customers for a product or service. First, the information in the panelist-keyword database 109 is keyed by different panelists such that each panelist in the panelist-keyword database 109 has an associated set of keywords. But it is often more useful for a company to find out which demographic sector of the public is interested in its product/service and then promote the product/server to the targeted demographic sector by launching a campaign at venues (such as websites or TV programs) that are appealing to the same demographic sector. The aggregate module 130 is responsible for aggregating the demographic data of the panelists and identifying the demographic information for different keywords. As noted above, a panelist who participates in the survey program has agreed to provide his or her personal information such as age, gender, education level, incoming level, geographical location, ethnicity, etc., to the survey system 40, which is stored in the panelist demographic database 113. In some implementations, the aggregate module 130 uses the conversion data associated with the panelists to adjust the aggregation of the demographic data of the panelists. For example, if a panelist purchases a particular product/service after visiting a website promoting the product/service or clicks a promotion link to the website promoting the product/service, the demographic data associated with this panelist is given more weight when aggregating the demographic data for a particular keyword that may be related to the product/service relative to other panelists that have no conversion data associated with the product/service.

Moreover, when a company (or its representative) sends a request to the survey system 40 for identifying potential customers for a product or service, it has no or little information about the demographic information of the potential customers. Typically, the company can only provide some information about the product/service it tries to promote (such as one or more keywords associated with the product/service), it is the responsibility of the survey system 40 to determine the demographic nature of the potential customers based on the information derived from the surveying results of the panelists. In other words, besides aggregating the demographic data of different panelists in the panelist-keyword database 109, the aggregate module 130 is responsible for inverting the relationship in the panelist-keyword database 109, generating a new relationship between the keyword and demographic attributes, and storing the relationship in the keyword-demographic attribute database 111. Unlike the panelist-keyword database 109, the new relationship in the keyword-demographic attribute database 111 is indexed by keywords. Using the keyword-demographic attribute database 111, the frontend module 120 can answer a query from a client for identifying potential customers for a product/service by identifying a set of demographic attributes for the product/service. As explained below, in some implementations the demographic attributes have a broad scope and they may include websites and TV programs that are popular among users/viewers who may be potential customers of the product/service. Based on the query results returned by the survey system 40, a company can develop an effective marketing strategy by targeting product/service campaigns at those potential customers.

In some implementations, the survey system 40 includes a product/service classifier 121 for identifying one or more categories for a product/service submitted by a company from a client. Using a category-keyword model 123, the product/service classifier 121 converts the categories associated with the product/service into a set of keywords and returns the keywords to the frontend module 120. Upon receipt of the keywords, the frontend module 120 then queries the keyword-demographic attribute database 111 for demographic attributes corresponding to the keywords associated with the product/service. As noted above, the keyword-demographic attribute database 111 includes a set of demographic attributes characterizing potential customers of a product/service for each keyword associated with the product/service. Next, the frontend module 120 generates a demographic characterization for the product/service by aggregating the demographic attributes corresponding to different keywords and returns information about the demographic characterization for the product/service for display at the client device.

FIG. 2 is a block diagram illustrating different components of the survey system 40 that are configured for analyzing the information consumption activities by the panelists and providing a demographic characterization of a product/service in response to a client request in accordance with some implementations. The survey system 40 includes one or more processors 202 for executing modules, programs and/or instructions stored in memory 212 and thereby performing predefined operations; one or more network or other communications interfaces 210; memory 212; and one or more communication buses 214 for interconnecting these components. In some implementations, the survey system 40 includes a user interface 204 comprising a display device 208 and one or more input devices 206 (e.g., keyboard or mouse).

In some implementations, the memory 212 includes high-speed random access memory, such as DRAM, SRAM, or other random access solid state memory devices. In some implementations, memory 212 includes non-volatile memory, such as one or more magnetic disk storage devices, optical disk storage devices, flash memory devices, or other non-volatile solid state storage devices. In some implementations, memory 212 includes one or more storage devices remotely located from the processor(s) 202. Memory 212, or alternately one or more storage devices (e.g., one or more nonvolatile storage devices) within memory 212, includes a non-transitory computer readable storage medium. In some implementations, memory 212 or the computer readable storage medium of memory 212 stores the following programs, modules and data structures, or a subset thereof:
an operating system 216 that includes procedures for handling various basic system services and for performing hardware dependent tasks;
a network communications module 218 that is used for connecting the survey system 40 to other computers (e.g., the client 20 in FIG. 1) via the communication network interfaces 210 and one or more communication networks (wired or wireless), such as the Internet 30 in FIG. 1, other wide area networks, local area networks, metropolitan area networks, etc.;
a frontend module 120 for receiving a request or query from a client 20 for identifying potential customers for a product/service, generating a demographic characterization of the potential customers, and returning information about the demographic characterization to the requesting client 20;
an analytics module 110 for processing information consumption activity data collected from a group of panelists and deriving a set of product/service keywords for each panelist;
an aggregate module 130 for aggregating demographic information of different panelists to define a set of demographic attributes for each product/service keyword;
a website-keyword model 101 including a plurality of entries, each entry 101-1 defining a set of keywords and associated weights for a respective website;
a web search-keyword model 103 including a plurality of entries, each entry 103-1 defining a set of keywords and associated weights for a respective web search;
a TV program-keyword model 105 including a plurality of entries, each entry 105-1 defining a set of keywords and associated weights for a respective TV program;
a panelist information consumption activity database 107 including a plurality of entries, each entry including a unique panelist ID 107-1 and associated data 107-3 including web search history, web browsing data, TV viewing data, conversion data, etc.;
a panelist-keyword database 109 including a plurality of entries, each entry 109-1 including a unique panelist ID, a keyword, and a weight indicating the keyword's relevance to the panelist's interest;
a panelist demographic database 113 including a plurality of entries, each entry including a unique panelist ID 113-1 and associated demographic data 113-3 including age, gender, education, income, geographical location, etc.;
a category-keyword model 123 including a plurality of entries, each entry 123-1 defining a set of keywords and associated weights for a respective category; and
a keyword-demographic attribute database 111 including a plurality of entries, each entry 111-1 defining a set of demographic attributes and associated weights for a respective keyword.

It should be noted that the modules, databases, and models in the survey system 40 describe above in connection with FIG. 2 may be implemented on a single computer server or distributed among multiple computer servers that are connected by a computer network. Although a specific hardware configuration may affect the performance of the survey system 40, the implementation of the present application does not have any dependency on a particular hardware configuration. On the other hand, the survey system 40 includes two logical subsystems: (i) a backend subsystem including the analytics module 110 and the aggregate module 130, which is responsible for aggregating the information consumption activity data collected from a group of panelists to generate a mapping relationship between keywords and demographic attributes; and (ii) a frontend subsystem including the frontend module 120 and the product/service classifier 120, which is responsible for receiving a request for identifying target customers for a product/service, classifying the product/service to determine a set of product/service keywords, and generating a demographic characterization of potential customers of the product/service by applying the set of keywords to the mapping relationship between keywords and demographic attributes developed by the backend subsystem. For illustrative purposes, the two subsystems, the backend subsystem followed by the frontend subsystem, are described separately below. But one skilled in the art would understand that this illustrative division of the survey system 40 is not necessary for implementing the present application.

FIGS. 3A and 3B are flow charts illustrating how the backend subsystem of the survey system 40 analyzes the information consumption activities data and other data associated with a group of panelists in order to characterize potential customers of the product/service in accordance with some implementations. The backend subsystem first collects (300) one or more information consumption activity data, conversion data, and demographic data from a plurality of panelists. As described above, the information consumption activity data associated with a respective panelist includes information about websites (including web pages) browsed by the panelist, web searches performed by the panelist, and TV programs watched by the panelist during a predefined time period (e.g., a day, a week or a month). In some implementations, each of the webpages, web searches, and TV programs is associated with one or more product/service keywords by the respective models such as the website-keyword model 101, the web search-keyword model 103, and the TV program-keyword model 105 shown in FIG. 1. In some implementations, the conversion data associated with a respective panelist includes information about a commercial transaction associated with a product/service purchased by the panelist in response to web-based and/or TV-based marketing information. In some other implementations, the conversion data associated with a respective panelist includes information about a visit to a website promoting a product/service by the panelist in response to web-based and/or TV-based marketing information. The conversion data is used for “highlighting” the panelist's interest in specific product/service and is reflected in the mapping relationship between a panelist and the associated keywords. In some implementations, the demographic data associated with a respective panelist includes information about the panelist's age, gender, education, income, ethnicity, language, geographical location, etc. As noted above, the panelists who participate in the survey program have agreed to provide their personal data to the survey system 40, which stores the personal data in the panelist demographic database 113.

The backend subsystem identifies (302) a set of product/service keywords for each panelist from the information consumption activity data associated with the panelist. The result mapping relationship between the panelist and the set of keywords from performing this operation are stored in the panelist-keyword database 109. In order to build the relationship between the panelists and the keywords, the backend subsystem may need to consult multiple pre-existing keyword models. As shown in FIG. 3B, the backend subsystem first determines (310) one or more webpages browsed by the panelist, one or more web searches performed by the panelist, and one or more TV programs performed by the panelist. For each type of information consumption activity data such as each of the webpages, web searches, and TV programs, the backend subsystem chooses (312) one or more product/service keywords according to the respective keyword models. Because the same keyword may be associated with different types of data, the backend subsystem then aggregates (314) the product/service keywords associated with the webpages, web searches, and TV programs and assigns a weight factor to each of the aggregated product/service keywords. In some implementations, the backend subsystem further identifies (316) a set of product/service keywords whose respective weight factors are higher than a predefined threshold level or have one of the top-N weight factors among the aggregated product/service keywords.

As noted above, the relationship between the panelists and the keywords is keyed by the panelists. The backend subsystem needs to converts it into a new relationship keyed by the keywords in order to characterize potential customers for a product/service. For each of the set of product/service keywords (304), the backend subsystem aggregates (306) the demographic data of the panelists who are associated with the product/service keyword using the conversion data. For example, if a panelist purchases a particular product/service that is characterized by the keyword, the conversion data associated with this commercial transaction is used for giving more weight to the demographic data of the panelist based on the assumption that another individual having similar demographic data is more likely to be interested in the product/service. Therefore, a company that promotes this type of product/service should “bias” its marketing efforts towards the demographic sector of which the panelist is a member. After the aggregation, the backend subsystem generates (308) a set of demographic attributes from the aggregated demographic data to be associated with the keyword.

FIGS. 4A and 4B are flow charts illustrating how the frontend subsystem of the survey system 40 generates a demographic characterization for a product/service in response to a request for identifying potential customers of the product/service in accordance with some implementations. After receiving (400) from a client device a request to identify potential customers of a product/service, the frontend subsystem determines (402) one or more categories for the product/service. For example, the product/service classifier 121 is configured to produce one or more categories for a product/service. From the categories, the frontend subsystem then identifies (404) a set of product/service keywords for each category. In some implementations, each product/service keyword has an associated set of demographic attributes characterizing potential customers of the product/service. For example, if the product is men's deodorant, the product/service classifier 121 may identify gender-men and ages [25-40] as the categories. The categories are then translated into keywords including men's hygiene, men's fragrance, etc.

Next, the frontend subsystem generates (406) a demographic characterization for the product/service by aggregating the sets of demographic attributes associated with the respective sets of product/service keywords and returns (408) information about the demographic characterization for the product/service for display at the client device. In some implementations, at least some sets of demographic attributes (e.g., the most commonly researched ones) associated with particular product/service keywords can be aggregated in advance of a customer request (e.g., once or twice per day). In some implementations, the demographic characterization includes an age distribution of customers of the product/service, a gender distribution of customers of the product/service, an education distribution of customers of the product/service, an income distribution of customers of the product/service, an ethnicity distribution of customers of the product/service, and a geographical distribution of customers of the product/service.

FIG. 4B further illustrates what information may be chosen as part of the demographic characterization of potential customers for a particular product/service. After identifying one or more categories for the product/service, the frontend subsystem selects (410) a set of websites/TV programs/web searches for each category. In some implementations, each website/TV program/web search has a weight factor associated with the category representing the closeness of the website/TV program/web search and the category. For example, the higher the weight factor of a website the more likely that visitors of the website would be interested in the particular category of products/services. Next, the frontend subsystem aggregates (412) the selected sets of websites/TV programs/web searches associated with the determined categories for the product/service and then identifies (414) a set of popular websites/TV programs/web searches for the product/service. For example, only those websites/TV programs/web searches whose aggregated weight factors are higher than a predefined threshold level would be included as part of the demographic characterization for a product/service. The frontend subsystem then returns (416) information about the identified set of popular websites/TV programs/web searches to be displayed on the requesting client device.

FIG. 5 is an exemplary screenshot 500 of a demographic characterization of a product/service displayed on a client device in accordance with some implementations. In this example, a representative from a customer (e.g., a company) logs into the customer's account at the survey system 40. This illustration presumes that the survey system 40 has pre-registered products and/services for different companies/customers. By clicking the dropdown list 520-1, the representative can choose his/her company or maybe another company (e.g., its competitor). The dropdown list 520-2 then shows all the products or services associated with the company chosen at the dropdown list 520-1. In some implementations, the survey system has already identified a set of categories 520-3 (referred to as verticals in the figure), which are returned to the client in response to a user selection of the dropdown list 520-2. In some implementations, the set of categories 520-3 is dynamically generated by the product/service classifier 121 in the survey system 40 after the user selection of the dropdown list 520-2 and then returned to the client. In some implementations, a user at the client can update the categories 520-3, e.g., adding new ones not in the list, remove existing ones, or modifying existing ones. After that, the user can submit a request to the survey system 40 for identifying potential customers for the products identified in the dropdown list 520-2 and further defined by the categories 520-2 by clicking the submit button 510.

In this example, the survey system 40 returns a demographic characterization of the potential customers for the product, which is then rendered on the display of the client like the one shown in FIG. 5. The demographic characterization includes one or more bar charts 530 depicting the distribution of potential customers in terms of age, gender, income, and education, etc. From these bar charts (or other types of visualization tools), the representative can achieve a good understanding of the demographic distributions of the potential customers. In addition, the demographic characterization also provides more specific information indicating what is popular among the potential customers and where/how the potential customers spend their time, e.g., the statistical information consumption activities 540 performed by the average customers who may be interested in the product or service. In some implementations, from analyzing the data samples associated with the panelists that have similar demographic attributes like the potential customers, the survey system 40 can suggest what TV programs 550 that the potential customers are most likely to watch as well as the websites that the potential customers are most likely to visit. From this holistic view of the demographic characterization of the potential customers, the company can make more informed decision on how to spend its marketing resources to maximize its return.

Reference has been made in detail to implementations, examples of which are illustrated in the accompanying drawings. While particular implementations are described, it will be understood it is not intended to limit the invention to these particular implementations. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the implementations.

Although the terms first, second, etc. may be used herein to describe various elements, these elements should not be limited by these terms. These terms are only used to distinguish one element from another. For example, first ranking criteria could be termed second ranking criteria, and, similarly, second ranking criteria could be termed first ranking criteria, without departing from the scope of the present invention. First ranking criteria and second ranking criteria are both ranking criteria, but they are not the same ranking criteria.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain principles of the invention and its practical applications, to thereby enable others skilled in the art to best utilize the invention and various implementations with various modifications as are suited to the particular use contemplated. Implementations include alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the implementations.

What is claimed is:

1. A method for selecting potential customers for a product/service, comprising:
at a computer server having memory and one or more processors:
collecting one or more of information consumption activity data, conversion data, and demographic data from a plurality of panelists;
identifying a set of product/service keywords for each panelist from the information consumption activity data associated with the panelist;
for each of the set of product/service keywords:
aggregating the demographic data of the plurality of panelists who are associated with the product/service keyword using the conversion data; and
generating a set of demographic attributes from the aggregated demographic data in order to characterize potential customers of the product/service.

2. The method of claim 1, wherein the information consumption activity data associated with a respective panelist includes information about webpages browsed by the panelist, web searches performed by the panelist, and TV programs watched by the panelist during a predefined time period, and each of the webpages, web searches, and TV programs is associated with one or more product/service keywords.

3. The method of claim 1, wherein the conversion data associated with a respective panelist includes information about a commercial transaction associated with a product/service made by the panelist in response to web-based and/or TV-based marketing information.

4. The method of claim 1, wherein the conversion data associated with a respective panelist includes information about a visit to a website promoting a product/service by the panelist in response to web-based and/or TV-based marketing information.

5. The method of claim 1, wherein the demographic data associated with a respective panelist includes information about the panelist's age, gender, education, income, ethnicity, language, and geographical location.

6. The method of claim 1, wherein identifying a set of product/service keywords for each panelist from the information consumption activity data associated with the panelist further includes:
determining one or more webpages browsed by the panelist, one or more web searches performed by the panelist, and one or more TV programs performed by the panelist;
choosing one or more product/service keywords for each of the webpages, web searches, and TV programs;
aggregating the product/service keywords associated with the webpages, web searches, and TV programs and assigning a weight factor to each of the aggregated product/service keywords; and
identifying, among the aggregated product/service keywords, a set of product/service keywords whose respective weight factors are higher than a predefined threshold level.

7. A method for generating a demographic characterization for a product/service, comprising:
at a computer server having memory and one or more processors:
receiving from a client device a request to identify potential customers of a product/service;
determining one or more categories for the product/service;
identifying a set of product/service keywords for each category, each product/service keyword having an associated set of demographic attributes characterizing potential customers of the product/service;
generating a demographic characterization for the product/service by aggregating the sets of demographic attributes associated with the respective sets of product/service keywords; and
returning information about the demographic characterization for the product/service for display at the client device.

8. The method of claim 7, wherein the demographic characterization includes at least one selected from the group consisting of an age distribution of customers of the product/service, a gender distribution of customers of the product/service, an education distribution of customers of the product/service, an income distribution of customers of the product/service, an ethnicity distribution of customers of the product/service, and a geographical distribution of customers of the product/service.

9. The method of claim 7, further including:
selecting a set of websites for each category, each website having a weight factor associated with the category;
aggregating the selected sets of websites associated with the determined categories for the product/service;
identifying a set of popular websites for the product/service by choosing the websites whose aggregated weight factors are higher than a predefined threshold level; and
returning information about the identified set of popular websites to the requesting client device.

10. The method of claim 7, further including:
selecting a set of TV programs for each category, each TV program having a weight factor associated with the category;
aggregating the selected sets of TV programs associated with the determined categories for the product/service;
identifying a set of popular TV programs for the product/service by choosing the TV programs whose aggregated weight factors are higher than a predefined threshold level; and
returning information about the identified set of popular TV programs to the requesting client device.

11. The method of claim 7, further including:
selecting a set of web searches for each category, each web search having a weight factor associated with the category;
aggregating the selected sets of web searches associated with the determined categories for the product/service;
identifying a set of popular web searches for the product/service by choosing the web searches whose aggregated weight factors are higher than a predefined threshold level; and
returning information about the identified set of popular web searches to the requesting client device.

12. A computer system for generating a demographic characterization for a product/service, comprising:
one or more processors; and
memory for storing one or more programs, wherein the one or more programs, when executed by the one or more processors, cause the computer system to perform the following instructions:
receiving from a client device a request to identify potential customers of a product/service;
determining one or more categories for the product/service;
identifying a set of product/service keywords for each category, each product/service keyword having an associated set of demographic attributes characterizing potential customers of the product/service;
generating a demographic characterization for the product/service by aggregating the sets of demographic attributes associated with the respective sets of product/service keywords; and
returning information about the demographic characterization for the product/service for display at the client device.

13. The computer system of claim 12, wherein the demographic characterization includes at least one selected from the group consisting of an age distribution of customers of the product/service, a gender distribution of customers of the product/service, an education distribution of customers of the product/service, an income distribution of customers of the product/service, an ethnicity distribution of customers of the product/service, a geographical distribution of customers of the product/service.

14. The computer system of claim 12, wherein the one or more programs further include instructions for:
selecting a set of websites for each category, each website having a weight factor associated with the category;
aggregating the selected sets of websites associated with the determined categories for the product/service;
identifying a set of popular websites for the product/service by choosing the websites whose aggregated weight factors are higher than a predefined threshold level; and
returning information about the identified set of popular websites to the requesting client device.

15. The computer system of claim 12, wherein the one or more programs further include instructions for:
selecting a set of TV programs for each category, each TV program having a weight factor associated with the category;
aggregating the selected sets of TV programs associated with the determined categories for the product/service;
identifying a set of popular TV programs for the product/service by choosing the TV programs whose aggregated weight factors are higher than a predefined threshold level; and
returning information about the identified set of popular TV programs to the requesting client device.

16. The computer system of claim 12, wherein the one or more programs further include instructions for:
selecting a set of web searches for each category, each web search having a weight factor associated with the category;
aggregating the selected sets of web searches associated with the determined categories for the product/service;
identifying a set of popular web searches for the product/service by choosing the web searches whose aggregated weight factors are higher than a predefined threshold level; and
returning information about the identified set of popular web searches to the requesting client device.

17. A computer system for selecting potential customers for a product/service, comprising:
one or more processors; and
memory for storing one or more programs, wherein the one or more programs, when executed by the one or more processors, cause the computer system to perform the following instructions:
collecting one or more information consumption activity data, conversion data, and demographic data from a plurality of panelists;
identifying a set of product/service keywords for each panelist from the information consumption activity data associated with the panelist;
for each of the set of product/service keywords:
aggregating the demographic data of the plurality of panelists who are associated with the product/service keyword using the conversion data; and
generating a set of demographic attributes from the aggregated demographic data in order to characterize potential customers of the product/service.

18. The computer system of claim 17, wherein the information consumption activity data associated with a respective panelist includes information about webpages browsed by the panelist, web searches performed by the panelist, and TV programs watched by the panelist during a predefined time period, and each of the webpages, web searches, and TV programs is associated with one or more product/service keywords.

19. The computer system of claim 17, wherein the conversion data associated with a respective panelist includes information about a commercial transaction associated with a product/service made by the panelist in response to web-based and/or TV-based marketing information.

20. The computer system of claim 17, wherein the conversion data associated with a respective panelist includes information about a visit to a website promoting a product/service by the panelist in response to web-based and/or TV-based marketing information.

21. The computer system of claim 17, wherein the demographic data associated with a respective panelist includes information about the panelist's age, gender, education, income, ethnicity, language, and geographical location.

22. The computer system of claim 17, wherein the instructions for identifying a set of product/service keywords for each panelist from the information consumption activity data associated with the panelist further include instructions for:
determining one or more webpages browsed by the panelist, one or more web searches performed by the panelist, and one or more TV programs performed by the panelist;
choosing one or more product/service keywords for each of the webpages, web searches, and TV programs;
aggregating the product/service keywords associated with the webpages, web searches, and TV programs and assigning a weight factor to each of the aggregated product/service keywords; and
identifying, among the aggregated product/service keywords, a set of product/service keywords whose respective weight factors are higher than a predefined threshold level.
